(19) United States
(12) Patent Application Publication
(10) Pub. No.: US 2023/0003890 A1
(43) Pub. Date: Jan. 5, 2023

(54) LIDAR WITH SUB-PIXEL RESOLUTION

(71) Applicant: Seagate Technology LLC, Fremont, CA (US)

(72) Inventors: Daniel Joseph Klemme, Robbinsdale, MN (US); Aditya Jain, Minneapolis, MN (US); Kevin A. Gomez, Eden Prairie, MN (US)

(21) Appl. No.: 17/853,372

(22) Filed: Jun. 29, 2022

Related U.S. Application Data
(60) Provisional application No. 63/216,722, filed on Jun. 30, 2021.

(51) Int. Cl. G01S 17/89; G01S 17/10; G01S 7/481

(52) U.S. Cl. CPC G01S 17/89; G01S 17/10; G01S 7/4817

(57) ABSTRACT

A light detection and ranging system can have a controller connected to an emitter and a detector. The controller may be configured to selectively move portions of the detector to increase a pixel resolution for a portion of a downrange field of view. The controller can utilize multi-spectral wavelength customization to further increase the pixel resolution of the detector.

### RELATED APPLICATIONS

The present application makes a claim of domestic priority under 35 U.S.C. 119(e) to U.S. Provisional Patent Application No. 63/216,722 filed Jun. 30, 2021, the contents of which being hereby incorporated by reference.

### SUMMARY

Light detection and ranging can be optimized, in various embodiments, by connecting a controller to an emitter and a detector. The controller selectively moves portions of the detector to increase a pixel resolution for a portion of a downrange field of view. The controller can utilize multi-spectral wavelength customization to further increase the pixel resolution of the detector.

### BRIEF DESCRIPTION OF THE DRAWINGS

FIG. 1 is a block representation of an example environment in which assorted embodiments can be practiced.

FIG. 2 plots operational information for an example detection system configured in accordance with some embodiments.

FIGS. 3A & 3B respectively depict portions of an example detection system arranged and operated in accordance with various embodiments.

FIGS. 4A & 4B respectively depict portions of an example detection system constructed and employed in accordance with some embodiments.

FIG. 5 depicts a block representation of portions of an example detection system employed in accordance with assorted embodiments.

FIG. 6 depict line representations of portions of an example detection system that may be utilized with in assorted embodiments.

### DETAILED DESCRIPTION

Various embodiments of the present disclosure are generally directed to optimization of an active light detection system.

Advancements in computing capabilities have corresponded with smaller physical form factors that allow intelligent systems to be implemented into a diverse variety of environments. Such intelligent systems can complement, or replace, manual operation, such as with the driving of a vehicle or flying a drone. The detection and ranging of stationary and/or moving objects with radio or sound waves can provide relatively accurate identification of size, shape, and distance. However, the use of radio waves (300 GHz-3 kHz) and/or sound waves (20 kHZ-200 kHz) can be significantly slower than light waves (430-750 Terahertz), which can limit the capability of object detection and ranging while moving.

The advent of light detection and ranging (LiDAR) systems employ light waves that propagate at the speed of light to identify the size, shape, location, and movement of objects with the aid of intelligent computing systems. The ability to utilize multiple light frequencies and/or beams concurrently allows LiDAR systems to provide robust volumes of information about objects in a multitude of environmental conditions, such as rain, snow, wind, and darkness. Yet, current LiDAR systems can suffer from inefficiencies and inaccuracies during operation that jeopardize object identification as well as the execution of actions in response to gathered object information. Hence, embodiments are directed to structural and functional optimization of light detection and ranging systems to provide increased reliability, accuracy, safety, and efficiency for object information gathering.

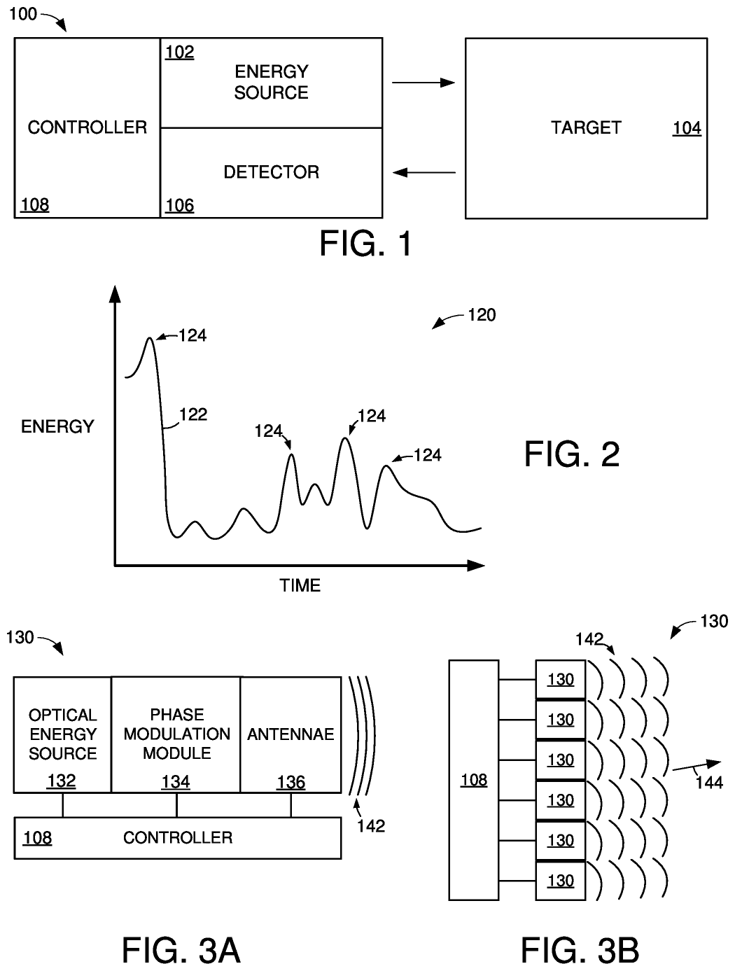

FIG. 1 depicts a block representation of portions of an example object detection environment 100 in which assorted embodiments can be practiced. One or more energy sources 102, such as a laser or other optical emitter, can produce photons that travel at the speed of light towards at least one target 104 object. The photons bounce off the target 104 and are received by one or more detectors 106. An intelligent controller 108, such as a microprocessor or other programmable circuitry, can translate the detection of returned photons into information about the target 104, such as size and shape.

The use of one or more energy sources 102 can emit photons over time that allow the controller 108 to track an object and identify the target's distance, speed, velocity, and direction. FIG. 2 plots operational information for an example light detection and ranging system 120 that can be utilized in the environment 100 of FIG. 1. Solid line 122 conveys the volume of photons received by a detector over time. The greater the intensity of returned photons (Y axis) can be interpreted by a system controller as surfaces and distances that that can be translated into at least object size and shape.

It is contemplated that a system controller can interpret some, or all, of the collected photon information from line 122 to determine information about an object. For instance, the peaks 124 of photon intensity can be identified and used alone as part of a discrete object detection and ranging protocol. A controller, in other embodiments, can utilize the entirety of photon information from line 122 as part of a full waveform object detection and ranging protocol. Regardless of how collected photon information is processed by a controller, the information can serve to locate and identify objects and surfaces in space in front of the light energy source.

FIGS. 3A & 3B respectively depict portions of an example light detection assembly 130 that can be utilized in a light detection and ranging system 140 in accordance with various embodiments. In the block representation of FIG. 3A, the light detection assembly 130 consists of an optical energy source 132 coupled to a phase modulation module 134 and an antennae 136 to form a solid-state light emitter and receiver. Operation of the phase modulation module 134 can direct beams of optical energy in selected directions relative to the antennae 136, which allows the single assembly 130 to stream one or more light energy beams in different directions over time.

FIG. 3B conveys an example optical phase array (OPA) system 140 that employs multiple light detection assemblies 130 to concurrently emit separate optical energy beams 142 to collect information about any downrange targets 104. It is contemplated that the entire system 140 is physically present on a single system on chip (SOC), such as a silicon substrate. The collective assemblies 130 can be connected to one or more controllers 108 that direct operation of the light energy emission and target identification in response to detected return photons. The controller 108, for example, can direct the steering of light energy beams 142 to a particular direction 144, such as a direction that is non-normal to the antennae 138, like 45°.

The use of the solid-state OPA system 140 can provide a relatively small physical form factor and fast operation, but can be plagued by interference and complex processing that jeopardizes accurate target 104 detection. For instance, return photons from different beams 142 may cancel, or alter, one another and result in an inaccurate target detection. Another non-limiting issue with the OPA system 140 stems from the speed at which different beam 142 directions can be executed, which can restrict the practical field of view of an assembly 130 and system 140.

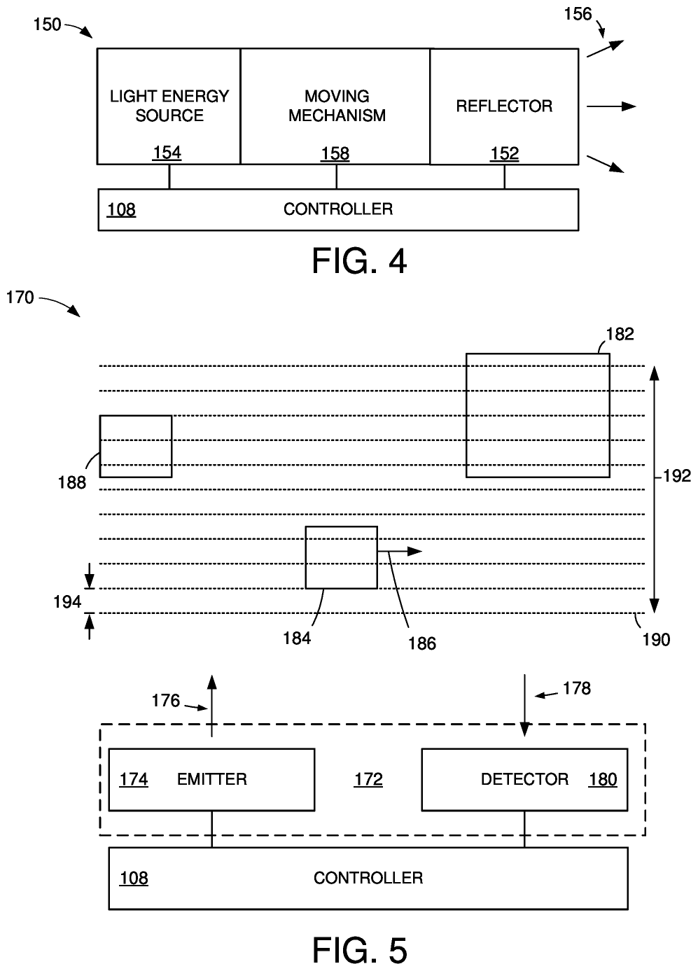

FIG. 4 depicts a block representation of a mechanical light detection and ranging system 150 that can be utilized in assorted embodiments. In contrast to the solid-state OPA system 140 in which all components are physically stationary, the mechanical system 150 employs a moving reflector 152 that distributes light energy from a source 154 downrange towards one or more targets 104. While not limiting or required, the reflector 152 can be a single plane mirror, prism, lens, or polygon with reflecting surfaces. Controlled movement of the reflector 152 and light energy source 154, as directed by the controller 108, can produce a continuous, or sporadic, emission of light beams 156 downrange.

Although the mechanical system 150 can provide relatively fast distribution of light beams 156 in different directions, the mechanism to physically move the reflector 152 can be relatively bulky and larger than the solid-state OPA system 140. The physical reflection of light energy off the reflector 152 also requires a clean environment to operate properly, which restricts the range of conditions and uses for the mechanical system 150. The mechanical system 150 further requires precise operation of the reflector 152 moving mechanism 158, which may be a motor, solenoid, or articulating material, like piezoelectric laminations.

FIG. 5 depicts a block representation of an example detection system 170 that is configured and operated in accordance with various embodiments. A light detection and ranging assembly 172 can be intelligently utilized by a controller 108 to detect at least the presence of known and unknown targets downrange. As shown, the assembly 172 employs one or more emitters 174 of light energy in the form of outward beams 176 that bounce off downrange targets and surfaces to create return photons 178 that are sensed by one or more assembly detectors 180. It is noted that the assembly 172 can be physically configured as either a solid-state OPA or mechanical system to generate light energy beams 172 capable of being detected with the return photons 178.

Through the return photons 178, the controller 108 can identify assorted objects positioned downrange from the assembly 172. The non-limiting embodiment of FIG. 5 illustrates how a first target 182 can be identified for size, shape, and stationary arrangement while a second target 184 is identified for size, shape, and moving direction, as conveyed by solid arrow 186. The controller 108 may further identify at least the size and shape of a third target 188 without determining if the target 188 is moving.

While identifying targets 182/184/188 can be carried out through the accumulation of return photon 178 information, such as intensity and time since emission, it is contemplated that the emitter(s) 174 employed in the assembly 172 stream light energy beams 176 in a single plane, which corresponds with a planar identification of reflected target surfaces, as identified by segmented lines 190. By utilizing different emitters 174 oriented to different downrange planes, or by moving a single emitter 174 to different downrange planes, the controller 108 can compile information about a selected range 192 of the assembly's field of view. That is, the controller 108 can translate a number of different planar return photons 178 into an image of what targets, objects, and reflecting surfaces are downrange, within the selected field of view 192, by accumulating and correlating return photon 178 information.

The light detection and ranging assembly 172 may be configured to emit light beams 176 in any orientation, such as in polygon regions, circular regions, or random vectors, but various embodiments utilize either vertically or horizontally single planes of beam 176 dispersion to identify downrange targets 182/184/188. The collection and processing of return photons 178 into an identification of downrange targets can take time, particularly the more planes 190 of return photons 178 are utilized. To save time associated with moving emitters 174, detecting large volumes of return photons 178, and processing photons 178 into downrange targets 182/184/188, the controller 108 can select a planar resolution 194, characterized as the separation between adjacent planes 190 of light beams 176.

In other words, the controller 108 can execute a particular downrange resolution 194 for separate emitted beam 176 patterns to balance the time associated with collecting return photons 178 and the density of information about a downrange target 182/184/188. As a comparison, tighter resolution 194 provides more target information, which can aid in the identification of at least the size, shape, and movement of a target, but bigger resolution 194 (larger distance between planes) can be conducted more quickly. Hence, assorted embodiments are directed to selecting an optimal light beam 176 emission resolution to balance between accuracy and latency of downrange target detection.

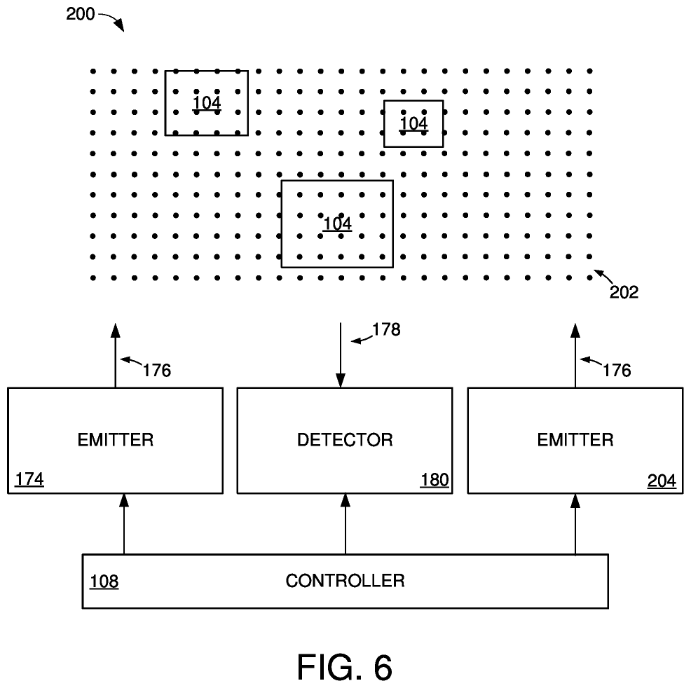

FIG. 6 depicts portions of an example light detection and ranging system 200 that can be employed in accordance with various embodiments. A system controller 108 can direct operation of at least one light beam emitter 174 and one or more photon detectors 180 to discover downrange targets 104. However, either pulsed or coherent light beam utilization results in a pixel resolution 202 that is not continuous and has some space between individual pixels, which can limit the system's 200 field of view.

Accordingly, embodiments are directed to intelligently identifying what is between pixels 202 by either moving the pixels 202 over time or moving portions of the detector 180 or emitter 174 over time. The movement of the pixels or detector 180 provides data that the controller 108 can then process into accurate identification of downrange information at a resolution greater than the existing pixel spacing. The detector 180 movement may be facilitated by physically tilting, rotating, or shifting the detector 180, or a secondary detector 204, relative to a downrange target 104 and/or the emitter 174 of the system 200.

It is contemplated that the controller 108 utilizes multi-spectral wavelength customization over time in combination with pixel/detector movement to scan downrange with a tighter resolution. The selective utilization of movement and/or wavelength customization allows the controller 108 to balance increased system 200 complexity with greater downrange accuracy. The controller 108, in some embodiments, generates one or more strategies to proactively prescribe actions that mitigate, prevent, or eliminate unwanted system 200 operation. For instance, the controller 108 can prescribe alterations in operation for portions of the system 200 to control electrical power consumption, enhance reliability of readings, and/or heighten performance.

As a non-limiting example, a power strategy can be generated by the controller 108 at any time and implemented upon an operational trigger, such as a detected, predicted, or selected emphasis on power consumption, to change one or more system 200 conditions to control power consumption. A power strategy may select a wavelength, set a pixel resolution, or move a detector 180/204 to save power, even if such actions have a lower accuracy, speed, or resolution. As such, a power strategy can prescribe activating, deactivating, or otherwise altering operation to control power consumption, even if such deviations degrade overall system 200 performance.

It is contemplated that the controller 108 can generate and execute a reliability strategy that proactively prescribes actions to provide maximum available consistency and accuracy in detecting and identifying downrange targets 104. For example, extra detectors 180/204 can be activated and operated to provide redundant readings of downrange targets 104 with similar, or dissimilar, light energy characteristics, such as wavelength, pulse width, or direction. Such operational deviations, in other embodiments, can be conducted as part of a preexisting performance strategy generated by the controller 108 to select wavelengths that optimize at least one performance metric, such as speed of detection, largest field of view, or tightest resolution. The ability to execute predetermined operational deviations to emphasize a selected theme, such as performance, reliability, or power consumption, allows the controller 108 to intelligently select wavelengths, activate detectors 180/204, and provide downrange resolution that produces optimal operation over time.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present technology to the full extent indicated by the broad general meaning of the terms in which the appended claims are expressed. For example, the particular elements may vary depending on the particular application without departing from the spirit and scope of the present disclosure.

What is claimed is:

1. An apparatus comprising an emitter and a detector each connected to a controller, the emitter configured to provide pixelated mapping of downrange targets with a resolution, the detector configured to provide sensing between pixels in response to movement of the emitter directed by the controller.

2. The apparatus of claim 1, wherein the pixelated mapping consists of a plurality of separate light beams sent downrange by the emitter.

3. The apparatus of claim 1, wherein the resolution corresponds with a distance between planes of pixels corresponding to separate beams of light sent downrange from the emitter.

4. A method comprising:
activating an emitter, as directed by a controller connected to the emitter, to send light beams downrange to provide a pixelated resolution;
moving the emitter relative to a detector, as directed by the controller, to provide a resolution greater than the pixelated resolution; and
sensing a target positioned downrange of the emitter with photons returning from the target to the detector.

5. The method of claim 4, wherein the emitter is physically moved.

6. The method of claim 5, wherein the emitter is tilted.

7. The method of claim 5, wherein the emitter is rotated.

8. The method of claim 5, wherein the emitter is shifted.

9. The method of claim 4, wherein the emitter sends light beams downrange while being moved.

10. The method of claim 4, wherein the emitter pauses operation until being moved.

11. A method comprising:
activating an emitter, as directed by a controller connected to the emitter, to send light beams downrange with a first wavelength selected by the controller to provide a first pixelated resolution;
moving the emitter relative to a detector, as directed by the controller, to provide a resolution greater than the first pixelated resolution;
sending light beams downrange with a second wavelength to detect objects between pixels of the first pixelated resolution; and
sensing a target positioned downrange of the emitter with photons returning from the target to the detector.

12. The method of claim 11, wherein the controller changes the first pixelated resolution to a different second pixelated resolution.

13. The method of claim 11, wherein the first wavelength is 1550 nm.

14. The method of claim 11, wherein the light beams are sent downrange in pulses, as directed by the controller.

15. The method of claim 11, wherein the light beams are sent downrange coherently.

16. The method of claim 11, wherein the controller changes to a second wavelength in response to a trigger event detected by the controller.

17. The method of claim 16, wherein the second wavelength is selected to conserve power consumption by the emitter and detector.

18. The method of claim 11, wherein the second wavelength is selected to increase target identification speed by the emitter.

19. The method of claim 11, wherein the second wavelength is selected to increase accuracy of target identification by the emitter and detector.

20. The method of claim 11, wherein the second wavelength is selected to increase a pixel resolution for less than an entirety of a downrange field of view of the emitter.
